(19) United States
(12) Patent Application Publication
(10) Pub. No.: US 2006/0022389 A1
(43) Pub. Date: Feb. 2, 2006

(54) Leaf spring assembly with forged fastener

(76) Inventors: Melvin Svendsen, Calgary (CA); Donald Stoesz, Langdon (CA); Simon Feng, Calgary (CA)

Correspondence Address: ADE & COMPANY, 1700-360 MAIN STREET, WINNIPEG, MB, R3C3Z3, CA

(21) Appl. No.: 11/193,632

(22) Filed: Aug. 1, 2005

Related U.S. Application Data
(60) Provisional application No. 60/592,383, filed on Aug. 2, 2004.

(51) Int. Cl. F16F 1/18

(52) U.S. Cl. 267/52; 267/36.1

(57) ABSTRACT

In an alternative assembly of multiple leaves in an assembled leaf spring; a forged fastener is used instead of a bolt and nut. To form the forged fastener, a cylindrical member with a preformed head on one end is inserted through the centre holes of each leaf of the leaf spring and the inserted end is forged in a press to match the head of the fastener on the other side. This is used to make a permanent connection, to make both sides of the fastener identical for use with an under-slung or over-slung axle arrangement, and to reduce process time by eliminating the need to cut and peen the conventional bolt.

This application claims benefit under 35 U.S.C.119 of the filing date of Provisional Application 60/592,383 filed Aug. 2^{nd} 2004.

This invention relates a leaf spring assembly comprising a plurality of leaf springs and a fasteners for connecting the leaf springs in a stack.

### BACKGROUND OF THE INVENTION

Leaf spring assemblies are conventionally used for suspending one component relative to another. One example relates to vehicle suspensions. However a leaf spring assembly can be used in many different situations and the present invention is applicable to any of these and is not intended to be limited to vehicle suspensions.

Such leaf springs comprise plurality of individual leaves of differing lengths which are connected together approximately at a center point along the length of the leaves. The major leaf which forms the longest length has fastening elements at its ends for attachment to a first component. A mounting element, such as an axle seat, is attached to the center of the leaf spring between the two ends for attachment to a second component to be suspended relative to the first component, for example the axle of the vehicle.

In the example of the vehicle suspension, with which the present invention is primarily concerned, such an axle seat can be over-slung or under-slung so that the axle is either mounted underneath the leaf spring on the convex side or above the leaf spring on the concave side. The axle seat includes an element which mounted on top of the springs and an element mounted underneath the springs. Both of these elements have a hole at the center into which the coupling for the leaves extends.

Conventionally such leaf springs are formed by inserting a bolt through the opening in the individual leaves for connecting the leaves together with head on one end of the bolt and a nut threaded on an exposed opposed end of the bolt.

Thus in some cases a leaf spring assembly is characterized by the direction in which the fastening bolt is inserted. This direction is determined by whether the spring has over-slung or under-slung mounting. Thus there may be two leaf spring assemblies that are identical in construction and leaf selection with the only difference that the bolt is inserted in opposite directions. For these two separate leaf spring assemblies, different assembly processes and inventories must be maintained, thus in effect doubling inventory and assembly problems.

### SUMMARY OF THE INVENTION

It is one object of the present invention therefore to provide an improved leaf spring assembly which overcomes or alleviates the above problems.

According to a first aspect of the invention there is provided a leaf spring assembly comprising:

a plurality of stacked leaf springs each having a fastening hole with the holes aligned for a fastener therethrough, the leaf springs including a bottom spring defining a bottom surface and a top spring defining a top surface;

a fastener connected through aligned holes in the leaf springs to hold the leaf springs in stacked relationship with one end at the top surface and another end at the bottom surface;

the fastener for the leaves comprising an elongate member that extends through the holes and has an end piece on each end defining a shoulder butting a respective one of the top surface ad the bottom surface;

the fastener being formed on at least one of the ends to form a forged end piece wherein the forged end piece is substantially identical to the other of the end pieces to make each of the end pieces of the fastener substantially identical.

Thus the invention provides an alternative way to attach individual leaves in a leaf spring assembly, in any manufacturing environment where either a permanent connection or a fastener is required that is identical on both ends, that is on both sides of the assembly.

Preferably each of the end pieces forms a cylindrical head.

Preferably the cylindrical heads have the same diameter.

Preferably the cylindrical heads have the same axial length.

Preferably one of the end pieces is preformed to define a head and the other of the end pieces is forged in place.

Preferably the fastener comprises a cylindrical body free from threads with a cylindrical head of larger diameter on one end and a forged head on the other end.

Preferably the assembly further includes a mounting coupling for attachment to the stacked leaf springs at the fastener, the mounting coupling including a plate for placement against either one of the top and bottom surfaces having a hole into which either one of the end pieces of the fastener will fit.

Preferably the mounting coupling includes an opposing member for placement against the other one of the top and bottom surfaces in opposition to the plate, the opposing member having a hole into which either one of the end pieces of the fastener will fit.

Preferably the plate and the opposing member are clamped together by bolts.

Preferably the assembly further includes an axle and the opposing member comprises a cradle for engaging a side face of the axle and the bolts are U-bolts which engage around the axle to clamp the cradle between the axle and the plate such that the axle can be under-slung with the cradle butting the bottom surface and the plate butting the top surface or the axle can be over-slung with the plate butting the bottom surface and the cradle butting the top surface.

By using a fastener that is identical on both sides only one assembly process and one inventory would be required.

Another advantage to this connection process is that it saves processing time. The steps in the bolt and nut attachment process include: threading on the nut, cutting the bolt after the nut is tightened if there is too much excess length, and peening the bolt so the nut cannot come off.

There can also be a material cost savings because nuts are no longer required and the fasteners do not need threads.

### BRIEF DESCRIPTION OF THE DRAWINGS

FIG. 1 is an isometric view of a fastener without threads for use in the construction according to the present invention.

FIG. 2 is an isometric view of a leaf spring assembly according to the present invention including the fastener, before forging, assembled with the leaves of a leaf spring.

FIG. 3 is an isometric view of the top die shaped to create the forged head on the fastener.

FIG. 4 is an isometric view similar to that of FIG. 2 showing the finished assembly with forged fastener.

FIG. 5 and FIG. 5A are respectively an isometric and an exploded view of the leaf spring assembly used in an under-slung axle and spring assembly.

FIG. 6 and FIG. 6A are respectively an isometric and an exploded view of the leaf spring assembly used in an over-slung axle and spring assembly.

### DETAILED DESCRIPTION OF THE PROCESS

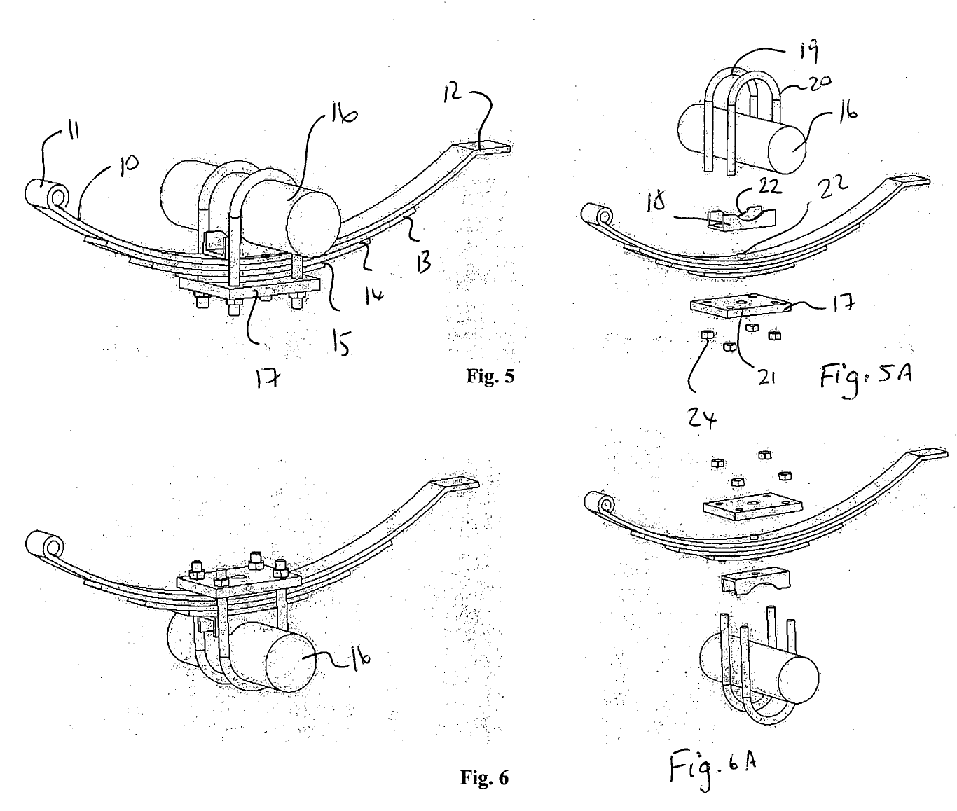

In FIGS. 5 and 6 is shown a leaf spring assembly which is completed by the attachment of the axle seat at the center of the spring assembly. Thus the leaf spring assembly comprises a main leaf 10 which has at its ends 11 and 12 suitable elements for attachment to a first component. In particular where the end use is in a vehicle suspension, the end 11 has a loop fastener formed integrally with the leaf 10 for coupling to a member of the vehicle frame and the end 12 has a flat strap for resting against the underside of a frame member of the vehicle.

The leaf spring assemblies shown in FIGS. 5 and 6 are identical as described hereinafter and are used differently in the two embodiments to provide the over-slung and under-slung constructions.

The leaf spring construction is made up of a number of further shorter leaves 13, 14 and 15 which lie underneath the main leaf on the convex side to provide additional spring resilience and additional strength for the spring in the central area, as is well known. The number of individual leaves can of course vary in accordance with the requirements. The techniques for mounting the leaf at its ends 11 and 12 are also variable in accordance with well known practice.

In the two embodiments shown; an axle 16 is mounted on the leaf spring. In the embodiment of FIG. 5, the axle is mounted on the upper side of the leaf spring in an over-slung manner. The mounting is effected by a tie plate 17 and an upper channel member 18 which are clamped together by a pair of U-bolts 19 and 20. The plate 17 is flat and has five holes. Four of the holes are arranged at the corners of the plate for receiving the ends of the U-bolts. The central hole 21 is located for receiving a fastener 22 for the leaf spring assembly as described hereinafter.

The channel member 18 defines two side walls, each of which has a concave recess 23 in the upper edge for receiving the bottom edge of the axle 16 pressed into the recesses with a common radius of curvature. The U-bolts 19 and 20 have upper semi-circular elements for engaging over the axle where the axle is clamped between the curved parts of the U-bolts and the recesses 23 when the U-bolts are passed through the holes in the plate 17 and clamped in place by nuts 24.

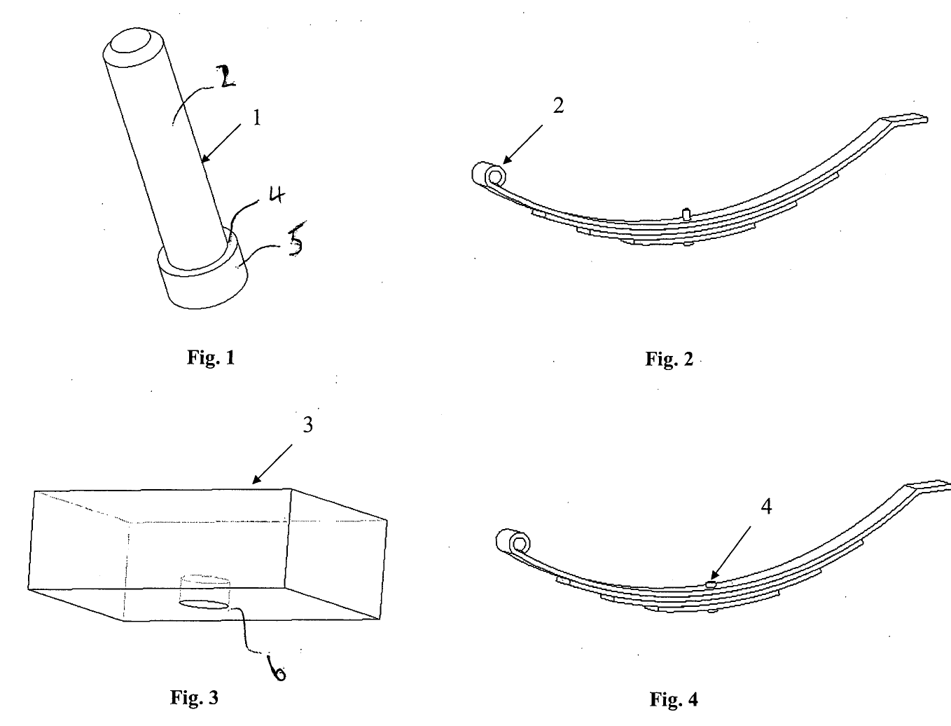

In FIG. 1 is shown a fastener 1 which has a cylindrical body 2 with a cylindrical end head 3 formed at one end. The cylindrical head 3 has a larger diameter thus forming a shoulder 4 facing along the length of the fastener. The end face of the head 5 is flat with a circular periphery.

The leaf springs 10, 13, 14 and 15 are assembled onto the fastener 1 in conventional manner so that the shoulder 4 engages against the bottom surface of the bottom leaf. In this way the head 5 is exposed beyond the bottom leaf 15 as a circular cylindrical element projecting outwardly therefrom to a short distance. The length of the head is sufficient to provide sufficient material to provide the required strength to hold the leaves together.

The opposite cylindrical end 9 of the fastener 1 projects beyond the top main spring 10 to a length greater than the length of the head 5.

A press 7 (shown only schematically) is provided which has a top press portion 7A and a bottom cooperating press portion 7B. The top portion 7A has a hole 6 formed which has a diameter equal to the diameter of the head 5. Thus when the press comes down onto the exposed end of the fastener 1 it forges the end part of the fastener which is exposed above the main leaf spring into the hole 6 to form it into the shape having the same diameter as the head 5.

If-the length of the fastener is selected to provide the required amount of material and if the length of the hole 6 is equal to the length of the head 5 then the end portion forged on the end the fastener is exactly identical to the head 5.

Thus to create the forged fastener with the forged head 8 as shown in FIG. 4, the fastener 1, which is similar to a bolt but without threads, is inserted through the centre holes in the leaves of the leaf spring assembly. Next, the assembly, including the fastener, is placed in a press. The die placed on the top part of the press 7 has the shape of the head of the fastener cut out of it. When the press is cycled the top die 7A comes down on top of the inserted end 9 of the fastener and forges it into the same shape 8 as the other end 5.

Some utility trailer leaf springs are characterized by the direction in which the centre bolt is placed. The head of the bolt is used to locate the spring properly on the axle seat. If the spring is under-slung the center bolt must be inserted from the top of the spring and if it is over-slung it must be inserted from the bottom. By forging a fastener, the same geometry as the head of the bolt that was used previously can be on the top and bottom of the spring and therefore only one assembly process and one inventory will be required to satisfy customers.

In an alternative arrangement, both the head 4 and the end portion 8 can be formed simultaneously in a forging action using two shaped holes in the top and bottom press portions.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A leaf spring assembly comprising:
a plurality of stacked leaf springs each having a fastening hole with the holes aligned for a fastener therethrough, the leaf springs including a bottom spring defining a bottom surface and a top spring defining a top surface;
a fastener connected through aligned holes in the leaf springs to hold the leaf springs in stacked relationship with one end at the top surface and another end at the bottom surface;
the fastener for the leaves comprising an elongate member that extends through the holes and has an end piece on each end defining a shoulder butting a respective one of the top surface ad the bottom surface;
the fastener being formed on at least one of the ends to form a forged end piece wherein the forged end piece is substantially identical to the other of the end pieces to make each of the end pieces of the fastener substantially identical.

2. The assembly according to claim 1 wherein each of the end pieces forms a cylindrical head.

3. The assembly according to claim 2 wherein the cylindrical heads have the same diameter.

4. The assembly according to claim 2 wherein the cylindrical heads have the same axial length.

5. The assembly according to claim 1 wherein one of the end pieces is preformed to define a head and the other of the end pieces is forged in place.

6. The assembly according to claim 1 wherein the fastener comprises a cylindrical body free from threads with a cylindrical head of larger diameter on one end and a forged head on the other end.

7. The assembly according to claim 1 further including a mounting coupling for attachment to the stacked leaf springs at the fastener, the mounting coupling including a plate for placement against either one of the top and bottom surfaces having a hole into which either one of the end pieces of the fastener will fit.

8. The assembly according to claim 7 wherein the mounting coupling includes an opposing member for placement against the other one of the top and bottom surfaces in opposition to the plate, the opposing member having a hole into which either one of the end pieces of the fastener will fit.

9. The assembly according to claim 8 wherein the plate and the opposing member are clamped together by bolts.

10. The assembly according to claim 9 including an axle and wherein the opposing member comprises a cradle for engaging a side face of the axle and wherein the bolts are U-bolts which engage around the axle to clamp the cradle between the axle and the plate such that the axle can be under-slung with the cradle butting the bottom surface and the plate butting the top surface or the axle can be over-slung with the plate butting the bottom surface and the cradle butting the top surface.
